(19) United States
(12) Patent Application Publication
(10) Pub. No.: US 2007/0272353 A1
(43) Pub. Date: Nov. 29, 2007

(54) Method and Apparatus of Sealing Seams in Segmented Bridges

(76) Inventors: Donald E. Wheatley, Ann Arbor, MI (US); Todd Jackson, Belleville, MI (US)

Correspondence Address: HARNESS, DICKEY & PIERCE, P.L.C., P.O. BOX 828, BLOOMFIELD HILLS, MI, 48303, US

(21) Appl. No.: 11/754,144

(22) Filed: May 25, 2007

Related U.S. Application Data
(60) Provisional application No. 60/809,077, filed on May 26, 2006.

(51) Int. Cl. B29C 65/00

(52) U.S. Cl. 156/304.3; 52/417

(57) ABSTRACT

A seal between abutting cement segments is provided, the cement segments each having a top surface, each top surface being substantially in the same plane. The seal comprises an epoxy adhesive in contact with the cement segment and a woven member The woven member comprises carbon fiber bundles, each of the bundles are bonded to the top surface of the cement segments.

### CROSS-REFERENCE TO RELATED APPLICATIONS

This application claims the benefit of U.S. Provisional Application No. 60/809,077, filed on May 26, 2006. The disclosure of the above application is incorporated herein by reference.

### FIELD

The present disclosure relates to the treatment of bridge and road surfaces and more particularly, to a method of sealing seams between bridge and road surface segments.

### BACKGROUND

The statements in this section merely provide background information related to the present disclosure and may not constitute prior art.

Segmented bridges have been used for many years as a cost effective and structurally sound bridge architecture. A typical segmented bridge may include pre-constructed bridge segments that are formed in predetermined lengths of for example 10 feet and full road widths of over 10 feet and more typically over 20 feet wide. The bridge segments are butted end to end and supported primarily by an interior cable system that runs through passages formed within the concrete bridge segments. A series of bridge segments comprise a bridge span that extends from one pillar to another. It is important to seal the seam that is created at the location where two bridge segments are butted together to prevent water from penetrating the seam and getting to the cable system where the water can cause corrosion of the support cables within the bridge segments. A prior method of sealing the seam has included cutting a groove along the upper surface of the bridge segments along the seam and filling the cut groove with an epoxy. However, the epoxy filled grooves are still capable of failure and it is desirable to provide a cost effective and improved method of sealing the seams between the bridge segments.

### SUMMARY

The present disclosure provides methods and apparatus for sealing the seams between bridge segments or any other road segments. Methods can optionally include cutting a groove along an upper surface of the bridge or road segments along a seam and filling the cut groove with an epoxy. According to the present disclosure, the epoxy is applied on opposite sides of the seam and a fibrous material is applied to the surface so as to span over the seam for the length of the seam. According to still another aspect of the present disclosure, the surface of the bridge or road segments along the seam may be etched or otherwise cleaned in order to enhance the adhesive ability of the epoxy.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a partial perspective view of a pair of cement segments and cables of a segmented bridge;

FIG. 2 is a partial perspective of a pair of cement segments, cables, and a sealed seam of a segmented bridge according to some embodiments of the present disclosure;

FIG. 3 is a cross-sectional view taken along line 3-3 of FIG. 2;

FIG. 4 is a perspective view of a fibrous material spanning a gap between a pair of cement segments and in contact with an adhesive according to some embodiments of the present disclosure;

FIG. 5 is a perspective view of a sealed seam according to some embodiments of the present disclosure;

FIG. 6 is a top view of a fibrous material according to some embodiments of the present disclosure;

FIG. 7 is a cross-section view taken along lines 7-7; and

FIG. 8 is an exploded view of FIG. 3.

### DETAILED DESCRIPTION

The following description is merely exemplary in nature and is not intended to limit the present disclosure, application, or uses. It should be understood that throughout the drawings, corresponding reference numerals indicate like or corresponding parts and features.

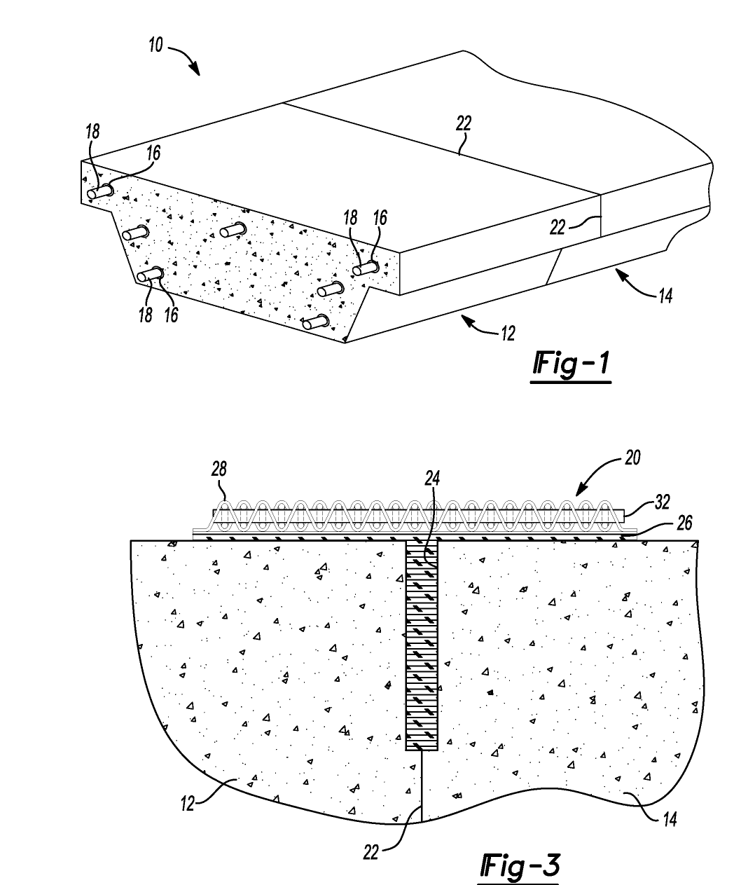

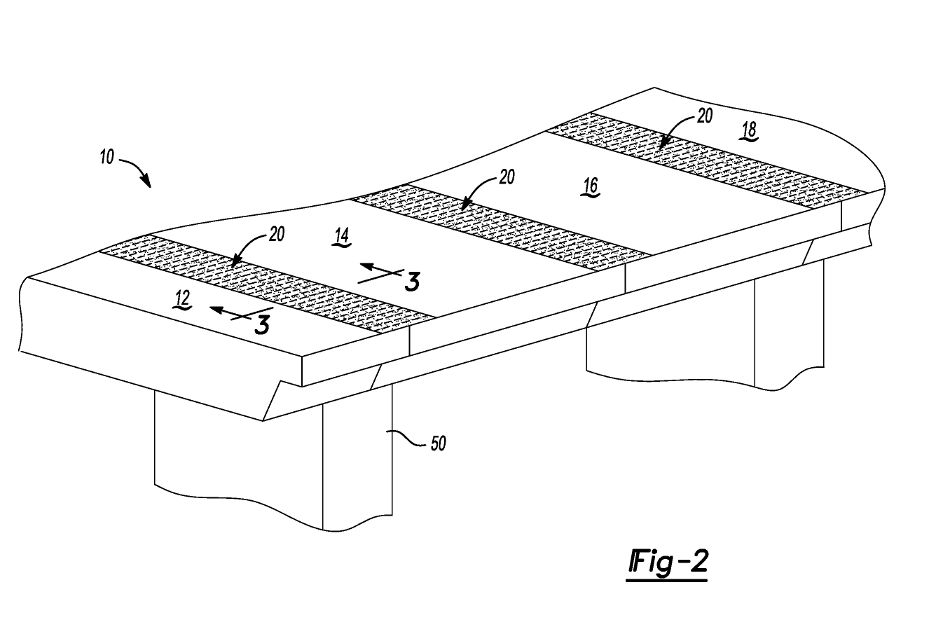

With reference to FIGS. 1-3, a portion of a segmented bridge 10 is shown including a first pre-constructed concrete bridge segment 12 and a second concrete bridge segment 14 that are shown butted together. The bridge segments 12, 14 each include passages 16 formed therein that receive a cable system (cables 18) that provides the primary support for the bridge segments 12, 14 as they extend between spaced pillars 50. A seam 22 is disposed between the bridge segments 12, 14. Optionally, a groove 24 can be cut or otherwise formed in the upper surface of the first and second bridge segments along the seam 22. The groove 24 can be filled with an epoxy adhesive material 26 such as an epoxy, an urethane sealant, a silicone sealant or other suitable sealants or combinations thereof.

An epoxy or other suitable adhesive material 26 is then applied along the surface of the bridge segments 12, 14 along the seam 22 and extending several inches therefrom. Preferably, the adhesive material 26 extends 2 to 12 inches in each direction on opposite sides of the seam 22. A strip of fibrous material 20 is then applied to the adhesive material 26 along the length of the seam 22. It should be noted that the adhesive material 26 may be applied to the fibrous material 20 or to the bridge segments 12,14, or both. The fibrous material 20 can include fiber bundles 32 which may include carbon fibers, Kevlar fibers, fiberglass, carbon fibers, poly-parapheneylene tetraphthalamide, para-aramid nylon, aramid fiber, aromatic polyamide, and combinations thereof or other suitable man made and naturally occurring fibers that exhibit satisfactory strength and flexibility characteristics. The fibrous bundles 32 may be secured with a thread (not shown). The fibrous material 20 may include one or more threads 28 that are woven to desired densities to allow proper wetting of the material during application with the adhesive material 26. The fibrous material 20 can also be precoated with the adhesive material 26 and pre-cured to provide a flexible, yet relatively rigid material that aids in application of the fibrous material 20. It is desirable that the adhesive material 26 wets into the fibrous material 20 and/or the spaces between the transverse fiber bundles 32 to provide a fiber reinforced water resistant cover to the seam 22.

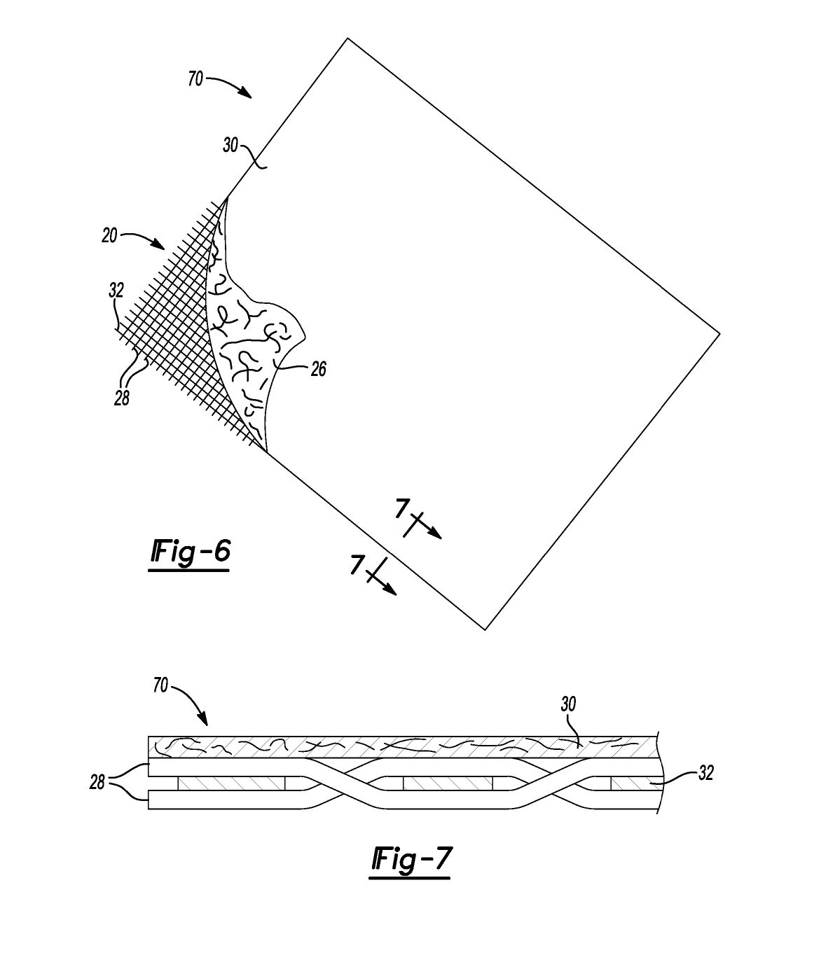

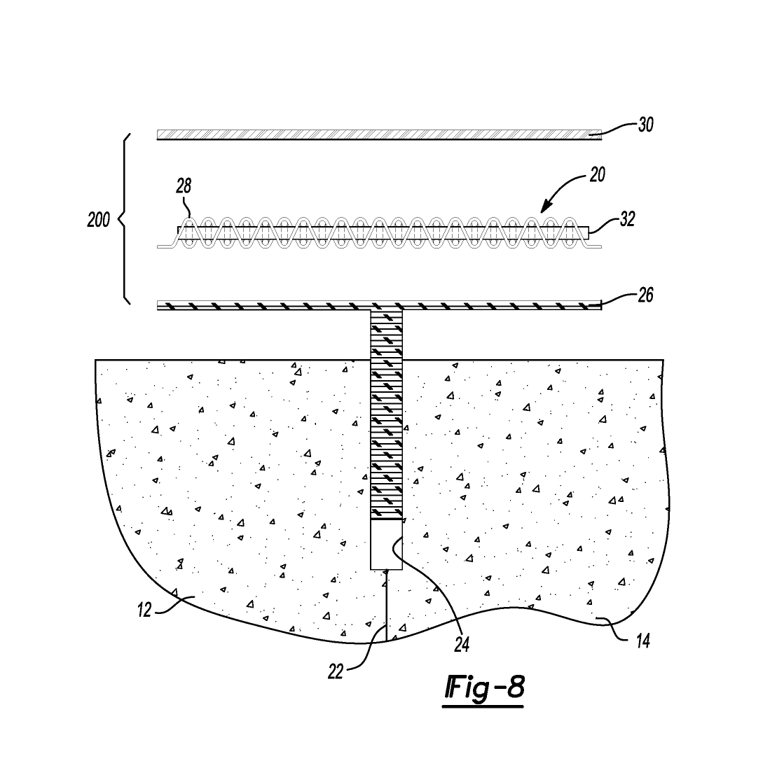

As shown in FIGS. 6-7, examples are illustrated according to the present disclosure of the rigidified fiber mesh tape 20, that can be used for sealing a seam 22 in a segmented bridge 10. The rigidified fiber mesh tape 20 comprises a number of transverse fibers 32 running the distance of the width of the mesh tape 106 and a number of longitudinal fibers or threads 28. The transverse fibers 32 run parallel to one another and are in tension. As best seen in FIG. 7, the longitudinal threads 28 can be woven into the transverse fibers 32, the longitudinal threads 28 alternating from a position above the transverse fibers 32 to a position below the transverse fibers 32. Alternatively, as best seen in FIG. 8, the longitudinal threads 28 sandwich the transverse fibers 32. In other words, the longitudinal threads 28 can be layered on top and below the transverse fibers 32, providing a fiber mesh 100 with a lower manufacturing cost. A further reduction of manufacturing cost may be achieved by providing only one of the layers of longitudinal threads 28, either on top or below.

The transverse fibers 32 and longitudinal threads 28 may be of any cross-sectional shape, such as flat (ribbon like), rectangular, oval or round. In the same embodiments, the longitudinal threads 28 have a flat cross-section, as seen in FIGS. 7-9, providing a large surface area to contact the segments 12 and providing a low bending stiffness in the plane of the mesh tape 20.

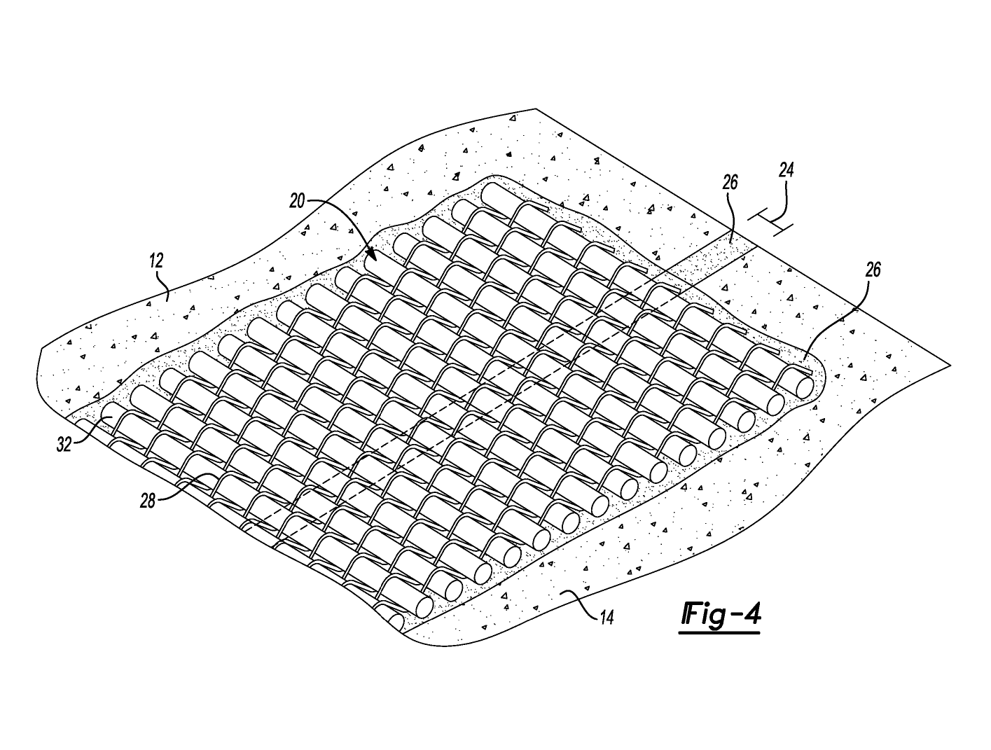

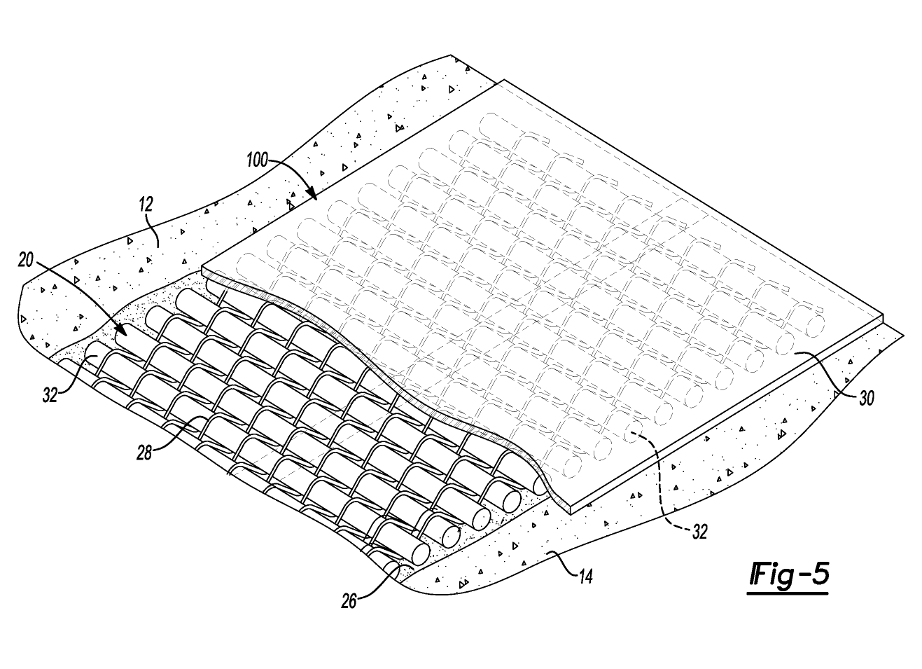

As shown in FIGS. 4-7, the longitudinal threads 28 are generally at 90-degree angles (transverse) to the transverse fibers 32. In some embodiments, the longitudinal threads 28 may be at 45-degree angles to the transverse fibers 32, or some angle between 45-degrees and 90-degrees. In a 45-degree fiber orientation, the longitudinal threads 28 tend to be loaded in tension along with the transverse fibers 32.

In some embodiments, the transverse fibers 32 and longitudinal threads 28 may be spaced anywhere from over 1 inch apart to less than 1/32 inches apart so long as the spacing is sufficient to allow adhesive to flow between the fibers 102, 104, discussed herein. The rigidified fiber mesh tape 20 has a roughened surface 28 exposed or produced upon removal of a cover sheet 24, as will be discussed in detail herein. In some embodiments, the transverse fibers 32 and/or the longitudinal thread 28 are made of pre-cured carbon, although any material providing flexibility and tensional strength may be used. Moreover, transverse fibers 32 and longitudinal threads 28 may be of different materials. For example, transverse fibers 32 may be Kevlar or bundles of Kevlar and longitudinal threads 28 may be a nylon or a nylon blend. Other examples of transverse fibers 32 include carbon fibers, poly-parapheneylene tetraphthalamide, para-aramid nylon, aramid fiber, aromatic polyamide, and combinations thereof. In some embodiments, transverse fibers can be in bundles or individual fibers. Other examples of longitudinal threads 28 can include nylon, polyester, polypropylene, nomex, cotton, carbon fibers, poly-parapheneylene tetraphthalamide, para-aramid nylon, aramid fiber, aromatic polyamide, and combinations thereof.

In some embodiments as shown in FIG. 6, the adhesive material 26 (discussed above) is applied to the first surface 36 of the rigidified fiber mesh tape 20 and a thin layer or at least some of the adhesive material 26 remains on the surface 36 of the rigidified fiber mesh tape 20. It should be noted that the openings between the transverse fibers 32 and longitudinal threads 28 remain unobstructed.

As discussed herein, to provide a strong bond between the rigidified fiber mesh tape 20, it is important to have the surface of the rigidified fiber mesh tape 20 clean and roughed. In order to keep the surface clean and provide a roughened surface, over the layer of adhesive material 26, on the surface 36 (and optionally on the surface 38), is applied a flexible cover sheet 30 of impermeable sheet or film comprising textile, nylon, a polymeric or plastic material. The side of the cover sheet 30 in contact with the adhesive material 26 preferably exhibits a texture, such as a woven texture surface 39. The carbon fiber 13 or rigidified fiber mesh tape 20, with the adhesive material 26 and the cover sheet 30 applied, are subject to high temperature and pressure, via known techniques, allowing the adhesive material 26 to cure. Once the adhesive material 26 has cured, the result is a rigid carbon fiber sheet or rigidified fiber mesh tape 20 having a removable cover sheet 30 covering one or both surfaces thereof. This rigid carbon fiber sheet or rigidified fiber mesh tape 20 may then be cut or sawn into the desired sizes. In this form, the rigidified fiber mesh tape 20 can be stored and/or shipped to a job site for use. With the rigidified fiber mesh tape 20, the resin applied during the manufacture of the open fabric tends to fill the window between the mesh. When the textured cover sheet is removed, these windows remain adhered to the cover sheet and leave the openings clear. Thus, the cover sheet provides both a roughened surface, but also open windows.

At the job site, the cover sheet 30 prevents dirt, grease and other debris from coming into contact with the rigidified fiber mesh tape 20. Immediately prior to use, the cover sheet 30 is removed, or more accurately peeled away, from the surface 36 of the carbon fiber strip or rigidified fiber mesh tape 20 leaving exposed a clean roughened surface 38. This roughened surface 38 is a result of at least two factors, individually or in combination. First, the textured surface 39 of the cover sheet 30 causes an impression to be formed in the adhesive material 26 on the surface 36 as it cures. Second, as the cover sheet 30 is removed from the mesh tape 20, some of the adhesive material 26 remains adhered to the plastic sheet 30 and breaks away from the rigidified fiber mesh tape 20.

With the method of the present disclosure, a cost effective and improved method of sealing the seams between bridge segments is provided. It is noted that the sealing method of the present disclosure may also be utilized on road or other bridge surfaces in which grooves or seams are often cut between large concrete or asphalt sections or when road sections are being patched. The use of an adhesive/fibrous seal along the seams between non-movable road or bridge surface sections can prevent the intrusion of water that can cause further cracking along the seams especially in colder climates.

As illustrated in the drawings, the rigidified fiber mesh tape 20 can be pre-cut and can be provided in suitable lengths for their intended use. As will be appreciated by those skilled in the art, a large sheet may be cut to the required sizes before adhering it to reinforce a structural element 12. In some embodiments, the fiber mesh tape 20 can be stored and/or shipped in rolls. In some embodiments, a fit can include adhesive material 26, mesh tape 20 and cover sheet 30, as illustrated in FIG. 8. In some embodiments, the fit can include a cutting tool for cutting mesh tape 20 into desired shapes.

What is claimed is:

1. A seal between abutting cement segments, the cement segments each having a top surface, each top surface being substantially in the same plane, the seal comprising an epoxy adhesive in contact with the cement segment and a woven member, the woven member comprising carbon fiber bundles, each of the bundles bonded to the top surface of the cement segments.

2. The seal according to claim 1 wherein the woven member comprises a plurality of threads woven around the bundles.

3. The seal according to claim 2 wherein the woven member comprises a second plurality of threads interwoven with the plurality of threads and the bundles.

4. The seal according to claim 1 wherein the cement segments are part of a bridge structure.

5. The seal according to claim 1 wherein the top surface is a roadway.

6. The seal according to claim 1 further comprising a polymeric film on top of the bundles and at least partially in contact with the epoxy adhesive.

7. The seal according to claim 1, wherein the seal is substantially flat.

8. The seal according to claim 1 wherein the seal is essentially smooth.

9. A method of sealing a seam between concrete road segments, the method comprising:
applying an epoxy to opposite sides of the seam; and
applying a fiber mesh on to the epoxy, the fiber mesh comprising a plurality of bundles of fibrous material and woven into a mesh by a thread, the plurality of bundles linking the concrete road segments together.

10. The method according to claim 9 further comprising cleaning the seam.

11. The method according to claim 10, wherein the cleaning the seam includes at least one of etching, steam cleaning, acid washing, sand blasting, power washing, and combinations thereof.

12. The method according to claim 9 further comprising topping the fiber mesh with a layer of epoxy.

13. The method according to claim 12 further comprising applying a polymeric film over the layer of epoxy.

14. The method according to claim 9 wherein the fiber mesh has a distance length greater than a distance of width.

15. The method according to claim 14 wherein the second thread runs the distance of the length.

16. The method according to claim 14 wherein the plurality of bundles run the distance of the width.

17. The method of claim 9 further cutting a groove into the seam.

18. The method according to claim 9 wherein the road segments are part of a bridge structure.

19. The method according to claim 9 wherein the seam is a crack.

20. The method according to claim 9 wherein the plurality of bundles of fibrous material comprises at least one of carbon fibers, poly-parapheneylene tetraphthalamide, para-aramid nylon, aramid fiber, aromatic polyamide, and combinations thereof.

21. The method according to claim 9 wherein the thread comprises at least one of nylon, polyester, polypropylene, nomex, cotton, carbon fibers, poly-parapheneylene tetraphthalamide, para-aramid nylon, aramid fiber, aromatic polyamide, and combinations thereof.

22. The method according to claim 9 wherein a second thread wraps said plurality of bundles of fibrous material and comprises at least one of nylon, polyester, polypropylene, nomex, cotton, carbon fibers, poly-parapheneylene tetraphthalamide, para-aramid nylon, aramid fiber, aromatic polyamide, and combinations thereof.

23. A system for sealing a gap between two concrete segments, the system comprising:
an adhesive substantially filling the gap; and
a mesh material spanning the gap and in contact with the adhesive.

24. The system according to claim 23, wherein said mesh material comprising a plurality of carbon fiber bundles woven together by a plurality of threads.

25. The system according to claim 24, wherein at least a portion of the plurality of carbon fiber bundles span the gap.

26. The system according to claim 24, wherein the plurality of fibrous bundles comprises at least one of carbon fibers, poly-parapheneylene tetraphthalamide, para-aramid nylon, aramid fiber, aromatic polyamide, and combinations thereof.

27. The system according to claim 24, wherein the plurality of threads comprises carbon fibers, poly-parapheneylene tetraphthalamide, para-aramid nylon, aramid fiber, aromatic polyamide, and combinations thereof.

28. The system according to claim 23, wherein the adhesive is one of epoxy, urethane sealant, silicone sealant and combinations thereof.

29. The system according to claim 23 further comprising a layer of the waterproof adhesive covering at least a portion of the mesh material.

30. The system according to claim 23 further comprising a polymeric film covering at least a portion of the mesh material.

31. A kit for sealing a seam on a bridge, the kit comprising:
an adhesive; and
a mesh material comprising a plurality of carbon fiber bundles woven together by a plurality of threads.

32. The kit according to claim 31 wherein the adhesive is epoxy.

33. The kit according to claim 31 wherein the mesh material is in a form of a roll.

34. The kit according to claim 31, further comprising a polymeric film covering at least one side of the mesh tape.
